(19) United States
(12) Patent Application Publication
(10) Pub. No.: US 2022/0184816 A1
(43) Pub. Date: Jun. 16, 2022

(54) PACKAGING PLANT

(71) Applicant: Uhlmann Pac-Systeme GmbH & Co. KG, Laupheim (DE)

(72) Inventors: Joerg RIEKENBRAUCK, Schwendi (DE); Stefan HAAGA, Bronnen (DE); Sebastian SCHARPF, Illerkirchberg (DE)

(21) Appl. No.: 17/549,374

(22) Filed: Dec. 13, 2021

(30) Foreign Application Priority Data
Dec. 14, 2020 (EP) 20213797.2

(51) Int. Cl. B25J 11/00; B65B 65/00; B65B 35/16; B65B 41/12; B65B 11/52; B25J 5/02; B25J 13/08; B25J 19/00; B25J 21/00

(52) U.S. Cl. CPC B25J 11/00; B65B 65/003; B65B 35/16; B65B 41/12; B25J 9/1035; B25J 5/02; B25J 13/08; B25J 19/0025; B25J 21/005; B65B 11/52

(57) ABSTRACT

The packaging plant comprises a packaging machine and a robot which is mounted on a transport truck that is repositionable along the packaging machine. The transport truck comprises a frame, a current collector, and a plurality of operating components. The frame is mounted so as to be movable along the packaging machine, has a bearing assembly for the robot, and supports the plurality of operating components. The current collector is configured to wirelessly connect to a current source. The plurality of operating components comprise at least one wireless data transmission device and one drive.

### CROSS-REFERENCE TO RELATED APPLICATIONS

This application claims the benefit of priority under 35 U.S.C. § 119 to European Patent Application No. 20 213 797.2, filed Dec. 14, 2020, the contents of which is incorporated herein by reference in its entirety.

### FIELD

The present disclosure relates to a packaging plant comprising a packaging machine and a robot which on a transport truck is repositionable along the packaging machine.

### BACKGROUND

Packaging plants in which robots on trucks are repositionable between a store which provides consumable materials and individual processing stations of the packaging plant, said robots supplying the processing stations with consumable materials, are known from the prior art. The possibilities in terms of the application of such robots are however very limited.

Conversely, if the robots are to support the operator of the plant in any other aspect, for example when changing over the format of the packaging plant, collaborating robots can be used. In order to guarantee a sufficient level of safety, said robots are however often limited in terms of the dimensions thereof and the forces that can be absorbed, and thus in turn in terms of the possible applications of said robots.

### SUMMARY

It is therefore an object of the present invention to provide a packaging plant having a robot which is able to be used in an ideally simple and flexible manner.

According to one aspect of the present disclosure, a packaging plant comprises a packaging machine having a plurality of processing stations that are arranged successively in a processing direction of the packaging machine, and a robot which is mounted on a transport truck, wherein the transport truck is repositionable along the packaging machine. The transport truck comprises a frame, a current collector, and a plurality of operating components. The frame is mounted so as to be movable along the packaging machine, has a bearing assembly on which the robot is mounted, and supports the plurality of operating components. The current collector for transmitting an electric current to the transport truck is configured to wirelessly connect to a current source. The plurality of operating components comprise a data transmission device which is configured to wirelessly communicate with a machine controller of the packaging machine, and a drive for moving the transport truck along the packaging machine. The plurality of operating components further preferably comprise at least one compressor, in particular a compressed air compressor and/or a vacuum pump.

Provided in this way is a packaging plant having a robot which on the transport truck carries along all operating components required for operating a plurality of different tools, such as holding and gripping installations, and as a result is able to be used in a flexible manner for a plurality of different tasks. Moreover, the transport truck and the robot are able to be operated and repositioned without a drag chain, as a result of which the flexibility is further enhanced, the maintenance input is reduced, and high requirements in terms of hygiene can be met.

In order for the plurality of operating components and the current collector to be supported, said operating components and said current collector are attached to the frame of the transport truck. Alternatively, the current collector and the plurality of operating components can also in each case be individually attached to a housing of the transport truck, said housing in turn being fastened to the frame or in a self-supporting manner forming a frame. This applies also to all further operating components and elements of the transport truck that are described hereunder and are supported or received, respectively, by the frame.

The transport truck is preferably able to be operated in a wireless manner, thus is not wire-bound. This means that no wires, in particular no current lines, signal lines or fluid lines, for connecting the transport truck to an external current source, control device, or fluid supply, respectively, are provided on the transport truck. Rather, the transport truck carries on board all components required to this end, or has wireless (current, data) connections. As a result, a drag chain which would otherwise be required for supplying the transport truck and the robot can be dispensed with, while the robot can at the same time handle a plurality of tasks.

The absence of a drag chain further leads to the transport truck and the robot being easier to clean, or such a drag chain, which is complex in terms of cleaning, not having to be cleaned, respectively. In one preferred embodiment, at least one first processing station of the plurality of processing stations of the packaging machine is arranged in a clean room and the transport truck with the robot, at least in the region of the first processing station, is likewise arranged in the clean room. The first processing station is preferably a filling station in which products are filled into an item of packaging. The application range of the robot can thus also be extended as a result.

The at least one compressor can be a compressed air compressor and/or a vacuum pump. The transport truck preferably comprises two compressors, one of which is configured as a compressed air compressor and the other as a vacuum pump. A plurality of compressed air compressors and/or a plurality of vacuum pumps can also be provided. The compressor by a fluid line is preferably connected to a tool of the robot, said tool being able to be activated by the fluid. For example, the tool can be a holding/gripping device or a clamping device which can be activated, in particular opened and closed, by compressed air from the compressed air compressor. The tool can also be a suction device, for example, which by negative pressure from the vacuum pump suctions items, in particular products to be packaged or portions of films, and as a result acquires said items for further handling.

The plurality of operating components of the transport truck can also comprise a hydraulic apparatus which is supported by the frame. The hydraulic apparatus by a hydraulic line is preferably connected to a tool of the robot, said tool being able to be activated by the hydraulic fluid, as described above in the context of the compressor.

The robot is preferably a multi-axis robot, preferably a robot with 2, 3, 4, 5 or 6 axes. The multi-axis robot can have a plurality of servomotors, wherein the number of the plurality of servomotors corresponds to the number of axes of the multi-axis robot. The robot thus comprises one servomotor on each axis.

It is preferable for the plurality of operating components to further comprise a control device for controlling the drive and for controlling the robot. A control device for controlling the drive hereunder is also referred to as the first control device, and a control device for controlling the robot hereunder is also referred to as the second control device. The first and the second control device can be configured so as to be mutually integral, i.e. formed by a common control device which assumes both functions. The first and the second control device can however also be configured so as to be mutually separate. The first control device is connected so as to communicate with the drive of the truck. The second control device is connected so as to communicate with the robot and in particular with each of the plurality of servomotors of the robot. The second control device for controlling a tool of the robot can also be connected so as to communicate with this tool, in particular with at least one control valve of the tool.

Further, the first and the second control device can be connected so as to communicate with the data transmission installation. By the data transmission installation, said first and said second control device can in turn be connected so as to communicate with the machine controller of the packaging machine. The frame of the transport truck also supports the first and the second control device.

The plurality of operating components can further comprise a control device for controlling the at least one compressor. The control device for controlling the at least one compressor hereunder is also referred to as the third control device and, in a manner analogous to the first and second control device, can be configured so as to be integral with the first and the second control device or so as to be separate therefrom.

The control device can generally also assume functions for guaranteeing the safety of personnel and for guaranteeing the safe operation of the transport truck and of the robot. To this end, the control device is connected so as to communicate with corresponding sensors, as described below.

The transport truck preferably comprises at least one first mains adapter and one second mains adapter which are in each case electrically connected to the current collector, wherein the first mains adapter for the electrical power supply of the plurality of operating components on the transport truck is configured to convert an input voltage to a first output voltage, and wherein the second mains adapter for the electrical power supply of the robot, in particular of each of the plurality of servomotors of the robot, on the transport truck is configured to convert the input voltage to a second output voltage. As a result, the voltages required in each case for the electrical power supply of the operating components and of the robot can be provided directly on the transport truck.

In particular, the first mains adapter can be electrically connected selectively to one or a plurality from the drive, the compressor, the first and the second control device, and the data transmission installation. The second mains adapter is preferably electrically connected to each of the plurality of servomotors of the robot. The input voltage is preferably an AC voltage between 200 V and 600 V, more preferably between 300 V and 500 V, most preferably between 350 V and 450 V. The first output voltage is preferably a DC voltage between 6 V and 32 V, more preferably between 12 V and 24 V. The second output voltage is preferably a DC voltage between 500 V and 700 V, more preferably between 550 V and 650 V. The frame of the transport truck also supports the first and the second mains adapter.

The plurality of components can further comprise at least one sensor. The at least one sensor is selected from an optical sensor, such as, for example, a camera system, for identifying goods to be transported, for documenting the operation of the robot or for monitoring an environment of the robot, one or a plurality of position sensors for identifying the position of the transport truck and/or of the robot, and an acceleration or vibration sensor for monitoring the transport truck and/or the robot. One position sensor can in each case be provided on the drive as well as on the servomotors of the robot. In order to identify operating positions, tools and workpieces, the sensor may also be a code-scanning sensor. Laser or radar sensors are also suitable for monitoring the environment of the robot. An additional sensor can also be a mechanical, capacitive or inductive sensor on a robotic tool for fulfilling the process tasks. The plurality of sensors can comprise an arbitrary number and combinations of the sensors described here.

The packaging plant in one preferred embodiment comprises at least one guide rail which runs along the packaging machine and preferably, at least in portions, parallel to the processing direction, wherein the frame of the transport truck is mounted so as to be movable on the at least one guide rail. The at least one guide rail preferably runs below the transport truck so that the latter, together with the robot, stands on the guide rail. The packaging plant preferably comprises two parallel guide rails, as described above, so as to enable ideally stable mounting and guiding of the transport truck.

The at least one guide rail preferably has a substantially C-shaped cross-sectional profile having a first leg, a second leg and a third leg, wherein the second and the third leg extend in a substantially perpendicular manner from in each case one end of the first leg. The first leg is preferably aligned so as to be substantially vertical, and the second and the third leg are aligned so as to be substantially horizontal. The transport truck in this instance is mounted between the second and the third leg of the guide rail, and as a result is supported in an upward as well as downward manner. The weight of the transport truck and of the robot arranged thereon here acts downward on the second leg. In the event of abrupt movements of the transport truck or of the robot, tilting moments may however arise, forces directed in an upward manner resulting from said tilting moments. These forces then act in an upward manner on the third leg of the guide rail. The transport truck can further also be supported laterally in relation to the first leg of the at least one guide rail. If two guide rails are provided, these are preferably arranged in such a manner that the openings thereof of the C-shaped cross-sectional profile face away from one another, i.e. that the second and the third legs of the two guide rails are aligned in opposite directions.

The at least one guide rail can have a turnout or a switch where the transport truck can be introduced and removed. As an alternative, for this purpose an access can preferably be provided at one end of the at least one guide rail. As a result, variously equipped transport trucks or robots can be introduced into the packaging plant in a simple manner, or transport trucks having contaminated robots can be removed for cleaning, for example.

In order for the transport truck to be movably mounted on the at least one guide rail, the transport truck preferably comprises a plurality of casters and the frame of the transport truck by the plurality of casters is mounted so as to be movable on the at least one guide rail. The plurality of casters completely supports the transport truck on the at least one guide ran, said plurality of casters thus absorbing the entire load of the transport truck and of the robot.

Each caster of the plurality of casters is preferably arranged between the second and the third leg of the at least one C-shaped guide rail. An upper side of the second leg in this instance forms a running surface for the casters. Moreover, each caster can be axially supported on the first leg of the at least one C-shaped guide rail. If two guide rails are provided, the transport truck preferably comprises a plurality of casters for each guide rail, in order to be mounted in an ideally stable manner.

Alternatively, the transport truck could also be mounted by a linear friction bearing, a floating bearing on a magnetic rail, or simply by wheels on the floor.

In one particularly preferred embodiment, the transport truck comprises a plurality of caster packs, wherein each caster pack comprises at least two casters, preferably three casters, of the plurality of casters and one support on which the at least two casters are rotatably mounted. The support can be configured so as to be integral with the frame of the transport truck, can be attached to the frame of the transport truck, or particularly preferably can be mounted so as to be pivotable on the frame of the transport truck. The transport truck preferably comprises two caster packs for each guide rail, wherein the two caster packs are mutually spaced apart in the longitudinal direction of the guide rail.

In order to achieve an ideally precise mounting of the transport truck on the at least one guide rail, one caster of the at least two casters of each caster pack can be adjustable in a direction perpendicular to the running surface of the at least one guide rail and preferably perpendicular to a rotation axis of the caster. To this end, the axis of the adjustable caster is preferably mounted so as to be correspondingly displaceable in the respective support. The running surface of the at least one guide rail is a face of the second leg of the at least one C-shaped guide rail that faces the casters. Each caster pack preferably comprises three casters, of which the central caster is adjustable perpendicular to the running surface. As a result of this configuration of the caster packs, it is achieved that the transport truck, together with the robot, in the direction of the weight is reliably supported on the at least one guide rail, on the one hand, while the adjustable caster can be precisely positioned in relation to the upper third leg of the at least one C-shaped guide rail so as also to safely support tilting moments or unexpected movements. As a result, the transport truck and the robot are mounted in an optimal manner and so as to run silently in any situation.

In order for the voltage to be wirelessly transmitted to the current collector, the packaging plant preferably comprises a current conductor, in particular a conductor cable or a conductor rail, wherein the current collector of the transport truck is in sliding contact with the current conductor. A wireless current supply which can be implemented in an effective and cost-effective manner is enabled as a result.

The current conductor is connected to a voltage source and by way of the latter supplies the current collector nd thus the transport truck with electric voltage. The current conductor is preferably arranged parallel to and at the height level of the at least one guide rail. For example, the current conductor runs at a spacing of 20 mm to 140 mm, more preferably of 40 mm to 80 mm, from the at least one guide rail. If two guide rails are provided, the current conductor can be arranged between the two guide rails or preferably laterally outside the two guide rails.

The current collector of the transport truck preferably partially surrounds the current conductor, so as to ensure a reliable and uninterrupted current supply. For example, the current collector is configured as a conductor rail which has a substantially rectangular cross section, and the current collector surrounds and contacts the conductor rail on at least two or three sides. The current conductor can also be configured so as to be integral with the guide rail.

Alternatively, the voltage could also be transmitted to the current collector by induction.

In order to move the transport truck along the packaging machine, the packaging plant can further comprise a rack which runs along the packaging machine, and the drive of the transport truck can comprise a pinion which engages with the rack. The drive of the transport truck preferably comprises an electric motor, the pinion being mounted on the driveshaft of said electric motor. The combination of rack and pinion is particularly well-suited for driving the transport truck because high forces can be transmitted and high rates of acceleration can be achieved. Moreover, a division of the rack can be chosen in such a manner that the rack as well as the at least one guide rail can be configured in a modular manner and a length of each rack module corresponds to a length of each guide rail module.

The rack is preferably arranged parallel to and at the height level of the at least one guide rail. For example, the rack in this instance runs at a spacing of 30 mm to 140 mm, more preferably of 50 mm to 80 mm, from the at least one guide rail. If two guide rails are provided, the rack can be arranged between the two guide rails or laterally outside the two guide rails. However, the rack can also be arranged on the at least one guide rail, for example on an upper side of the third leg of the C-shaped guide rail.

it is further preferable for the rack to be arranged in such a manner that teeth of the rack are directed towards the side. The tips or end faces of the teeth of the rack in this instance run substantially vertically and not horizontally. It is prevented as a result that contamination can accumulate in the troughs between the teeth, good cleaning of the packaging plant being further facilitated as a result.

Alternatively, driving the transport truck can also take place by way of driven wheels, an (electromagnetic) linear drive, a pulley, or a (timing) belt drive.

In order to be able to even better clean the packaging plant, the packaging plant preferably comprises a cover in the region of the at least one guide rail. The cover is preferably configured in multiple parts and forms a casing in which the at least one guide rail and preferably also the current conductor and the rack are received, as a result of which said guide rail, said current conductor and said rack in relation to the plurality of processing stations of the packaging machine are protected against contamination. The cover, or the casing formed by the latter, respectively, has a gap above and along the at least one guide rail, the transport truck being mounted on the at least one guide rail through said gap. In the case of two guide rails, the cover, or the casing, respectively, correspondingly has two gaps. Brushes which further reduce contamination of underlying regions but do not compromise the mobility of the transport truck can be provided in each gap. It is also conceivable that the transport truck further comprises a cleaning device, in particular in the form of a suction device, so as to clean the gap and/or the underlying regions. In order to avoid the contamination of the gap, the cover can also be configured in such a manner that the latter dynamically opens ahead of the passing transport truck and doses behind the latter.

In one further embodiment, the packaging plant comprises at least one further robot which is mounted on a further transport truck, wherein the further transport truck is repositionable along the packaging machine. The further robot and the further transport truck can be configured according to the preceding description and consequently have all features of the robot, or the transport truck, respectively, described herein. In order to facilitate the description of the robot and of the further robot, said robot and said further robot hereunder are also referred to as the first and the second robot. In order to facilitate the description of the transport truck and of the further transport truck, said transport truck and said further transport truck hereunder are also referred to as the first and the second transport truck. It is understood that an arbitrary plurality of robots or transport trucks, respectively, can also be provided in an analogous manner.

The first and the second transport truck are preferably arranged on the same at least one guide rail. The first and the second robot can handle different tasks, for example have different tools. In order for the efficiency to be increased, the first and the second robot can in each case also be assigned to part of the plurality of processing stations of the packaging machine so as to keep the travel distances short.

A reliable, secure and rapid data transmission is guaranteed in that the data transmission device is preferably an optical data transmission installation. The optical data transmission can take place by optical transmission in free space, for example by laser or infrared. The data transmission by the data transmission device preferably takes place at a data transmission rate of at least 16 Mbits/s, more preferably at least 50 Mbits/s, most preferably at least 100 Mbits/s.

The packaging plant preferably comprises an optical transmission installation which can be configured as a freely emitting transmitter. The data transmission device is preferably connected so as to communicate with the machine controller of the packaging machine. The data transmission device on the transport truck comprises a corresponding receiver. A light beam for the transmission of data is aligned between the transmission installation and the data transmission installation.

It is understood that the transmission of data can also take place in a bidirectional manner and the transmission installation as well as the data transmission device are configured as a transmitter as well as a receiver. In order for the transmitter and receiver as well as the light beam to be protected, at least the data transmission device and preferably also the transmission installation can be arranged in the region of the at least one guide rail, in particular below the cover, or within the casing formed by this cover, respectively.

In one preferred embodiment, the data transmission device comprises a first communications interface and a second communications interface, wherein the first communications interface is configured to communicate with the machine controller, and the second communications interface is configured to communicate with a data transmission device of the second transport truck.

Consequently, the first communications interface corresponds to the previously described receiver of the data transmission device of the transport truck. The first communications interface is therefore attached to the first transport truck so as to face the transmission installation of the packaging plant. The second communications interface is attached to the first transport truck so as to face the second transport truck. A signal intended for the second transport truck can be transmitted from the transmission installation to the first communications interface of the first transport truck, and from the first transport truck by the second communications interface be sent to the data transmission device of the second transport truck.

Finally, the plurality of processing stations comprise at least one forming station, one filling station, one sealing station, one punching station, and one cartoner, wherein the robot is repositionable along all processing stations of the plurality of processing stations. The packaging plant further comprises at least one assembly area for consumable material, wherein the robot is configured to supply the plurality of processing stations with consumable material. The packaging machine in this case is preferably configured as a blister pack machine.

The packaging machine as a processing station in the processing direction can further comprise an entry region for example for providing a forming film and/or a cover film ahead of the forming station, a heating device ahead of the forming station, a transfer device to a transport device between the punching station and the cartoner, and a supply device for accompanying material in the pack, such as brochures or leaflets. The robot can be configured to interact with at least part of these stations or devices, respectively, or with each of these stations or devices, respectively.

For example, the robot can be configured to fill the packaging machine in the entry region with a new roll of a forming film and/or of a cover film, when required. The robot, in particular when changing the format, can be configured to place a lead of the forming film and/or of the cover film into the packaging machine. To this end, the robot guides a free end portion of the forming film or cover film, respectively, through the plurality of processing stations and about deflection elements in the packaging machine. Further, the robot can be configured to replace at least one product hopper of the filling station with a filled product hopper, or for filling the at least one product hopper with products, when required. The robot, in particular when changing the format, can further be configured to replace tools of the plurality of processing stations, such as, for example, a forming tool of the forming station, a sealing tool of the sealing station, or a punching tool of the punching station. Finally, the robot can also be configured to clean at least one processing station of the plurality of processing stations, such as the filling station, for example. Suitable to this end is, for example, cleaning by compressed air or CO2, by a suction device or a wiping device.

### BRIEF DESCRIPTION OF THE DRAWINGS

FIG. 1 schematically shows a packaging plant according to one embodiment of the invention in a perspective view.

FIG. 2 schematically shows a transport truck of the packaging plant of FIG. 1 in a perspective view, with the components received by said transport truck.

FIG. 3 schematically shows a fragment of the packaging plant of FIG. 1 in a perspective sectional view.

FIG. 4 schematically shows the fragment of FIG. 3 in a perspective view.

FIG. 5 schematically shows a transport truck having a robot of FIGS. 1 to 4 in a perspective view.

FIGS. 6, 7 show a caster pack of the transport truck of FIGS. 1 to 5.

### DETAILED DESCRIPTION

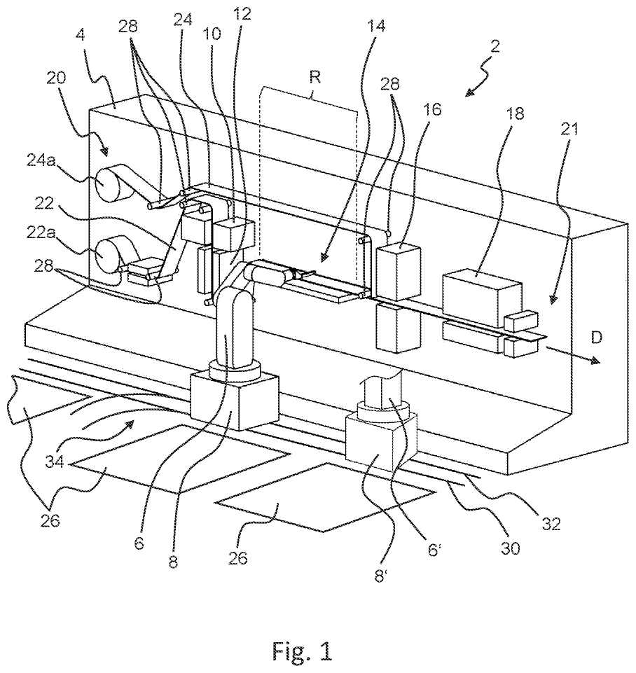

One embodiment of a packaging plant 2 according to the invention is schematically illustrated in FIG. 1. The packaging plant 2 comprises a packaging machine 4 as well as a robot 6 which is mounted on a transport truck 8. The transport truck 8 is repositionable along the packaging machine 4. The packaging machine 4 comprises a plurality of processing stations, such as, for example, a heating device 10, a forming station 12, a filling station 14, a sealing station 16, a punching station 18, as well as arbitrary further processing stations (not illustrated), which may include a transfer device, a transport device, a supply device for accompanying material in the pack, such as brochures or leaflets, and a cartoner, the aforementioned being downstream of the punching station 18. The plurality of processing stations 10, 12, 14, 16, 18 are arranged successively in a processing direction D of the packaging machine 4, said processing direction D being directed from an entry region 20 of the packaging machine 4 to an exit region 21 of the packaging machine 4.

The packaging machine 4 is preferably configured as a blister pack machine having an entry region 20 in which a forming film 22 on a roll 22a and a cover film 24 on a roll 24a can be provided. In this case, the forming film 22 runs through the heating device 10 for heating the forming film 22, the forming station 12 for forming product receptacles, such as blister cups, in the forming film 22, the filling station 14 for filling products into the product receptacles of the forming film 22, the sealing station 16 for sealing the cover film 24 on the forming film 22, and the punching station 18 for punching individual blister packs from the composite of the forming film 22 and the cover film 24.

The robot 6 is configured to interact with the packaging machine 4. The robot 6 is in particular configured to interact with the plurality of processing stations 10, 12, 14, 16, 18 and is therefore preferably repositionable along all processing stations of the plurality of processing stations 10, 12, 14, 16, 18. Thus, the packaging plant 2 can further comprise at least one assembly area 26, or, as illustrated, a plurality of assembly areas 26, for consumable material, and the robot 6 in this instance is configured to supply the plurality of processing stations 10, 12 14, 16, 18 with consumable material.

For example, further rolls 22a, 24a of the forming film 22, or of the cover film 24, respectively, can be provided in the assembly area 26 close to the entry region 20, and the robot 6 is configured to fill the packaging machine 4 in the entry region 20 with a new roll 22a, 24a, when required. The robot 6, in particular when changing the format, can also be configured to place a lead of the forming film 22 into the packaging machine 4. To this end, the robot guides a free end portion of the forming film 22 through the plurality of processing stations 10, 12, 14, 16, 18 and about deflection elements 28 in the packaging machine 4. In an analogous manner, the robot 6 can also be configured to place a lead of the cover film 24 into the packaging machine 4 in that said robot 6 guides a free end portion of the cover film 24 about deflection elements 28 in the packaging machine 4 and at least into the sealing station 16. Further, the robot 6 can be configured to replace at least one product hopper of the filling station 14 with a filled product hopper, or for filling the at least one product hopper with products, when required. The robot 6, in particular when changing the format, can further be configured to replace tools of the plurality of processing stations 10, 12, 14, 16, 18, such as, for example, a forming tool of the forming station 12, a sealing tool of the sealing station 16, or a punching tool of the punching station 18. Finally, the robot 6 can also be configured to clean at least one processing station of the plurality of processing stations 10, 12, 14, 16, 18, such as the filling station 14, for example. Suitable to this end is, for example, cleaning by compressed air or CO₂.

At least one first processing station of the plurality of processing stations 10, 12, 14, 16, 18 can be arranged in a clean room R so that the robot 6 in the region of the first processing station is also arranged in the clean room. In the embodiment illustrated, the first processing station corresponds to the filling station 14. The clean room R is configured between borders indicated by dashed lines and therein usually delimited from the other processing stations 10, 12, 16, 18 of the plurality of processing stations 10, 12, 14, 16, 18 by suitable partitions.

A further robot 6′ which is mounted on a further transport truck 8 is indicated in FIG. 1, wherein the further transport truck 8′ is also repositionable along the packaging machine 4. As a result of the packaging plant 2 thus comprising a plurality of robots 6, 6′, said robots 6, 6′ can either be equipped with different tools for undertaking different tasks and/or be assigned to different processing stations of the plurality of processing stations 10, 12, 14, 16, 18.

The packaging plant 2 comprises at least one guide rail 30, preferably two parallel guide rails 30, 32, which run along the packaging machine 4, wherein the transport truck 8 is mounted so as to be movable on the guide rails 30, 32. The guide rails 30, 32 preferably run parallel to the processing direction D of the packaging machine 4. In order for the transport truck 8 to be introduced or removed, a turnout or switch 34 on which the transport truck 8 can be guided onto the guide rails 30, 32 or away from the guide rails, respectively, can further be provided.

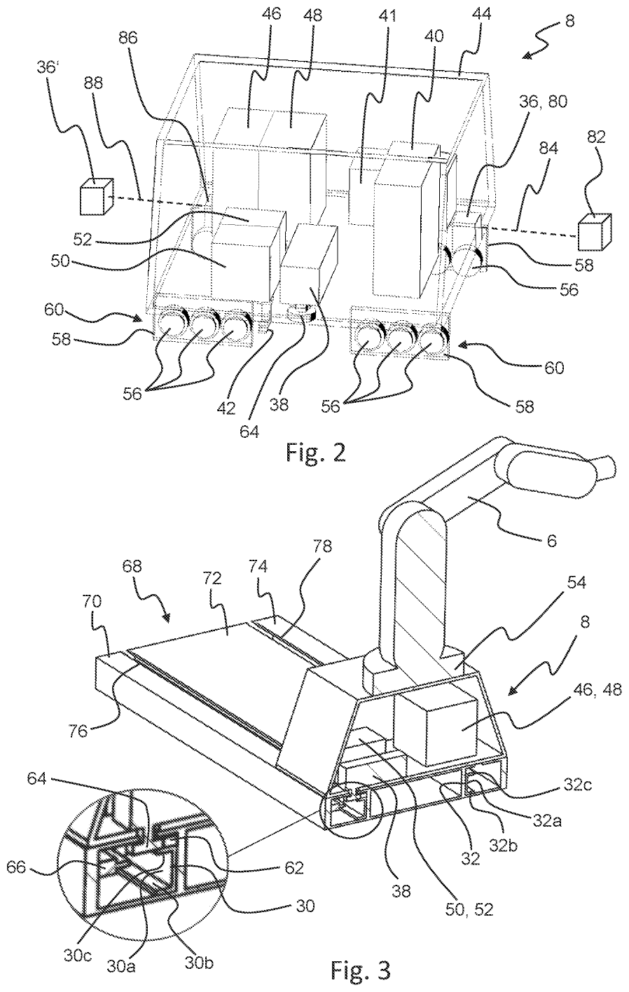

The transport truck 8 is described in more detail hereunder with reference to FIGS. 2-5.

As can be seen in FIG. 2, the transport truck 8 comprises a plurality of operating components, which comprise, for example, a data transmission device 36 for wirelessly communicating with a machine controller of the packaging machine 4, a drive 38 for moving the transport truck 8 along the packaging machine 4, and at least one compressor 40, 41. The transport truck 8 moreover comprises a current collector 42 for transmitting an electric current to the transport truck 8.

The data transmission device 36 can be an optical data transmission installation. The transport truck 8 here comprises two compressors, one of which is configured as a compressed air compressor 40 and the other as a vacuum pump 41. The current collector 42 is configured to wirelessly connect to a current source. The compressor 40 can be a compressed air compressor for supplying the robot with compressed air and/or a vacuum pump for supplying the robot with negative pressure.

The transport truck 8 further comprises a frame 44 which supports the plurality of operating components, thus the data transmission device 36, the drive 38, and the compressor 40, as well as the current collector 42. The frame 44 of the transport truck 8 preferably also supports all further operating components and installations of the transport truck 8 that are described herein. For example, the plurality of operating components of the transport truck 8 also comprises a first control device 46 for controlling the drive 38 and a second control device 48 for controlling the robot 6.

Further, the plurality of operating components can comprise a first mains adapter 50 and a second mains adapter 52, each being electrically connected to the current collector 42. The first and the second mains adapter 50, 52 are provided for supplying electric power to the operating components on the transport truck 8 and to the robot 6, and convert an input voltage that is received from the current collector 42 to various output voltages. In particular, the first mains adapter 50 for supplying the plurality of operating components converts the input voltage to a first output voltage of, for example, 24 V. The second mains adapter 52 for supplying the robot 6 can convert the input voltage to a second output voltage of, for example, 600 V.

As can be seen in FIGS. 3-5, the frame 44 moreover comprises a bearing assembly 54 which supports the robot 6. The robot 6 here comprises a first through to a fourth arm 55a-d of which in each case two adjacent arms are connected to one another in an articulated manner about at least one axis 6a-f. Illustrated in FIG. 5 are a first axis 6a, a second axis 6b, a third axis 6c, a fourth axis 6d, a fifth axis 6e and a sixth axis 6f about which the arms 55a-d of the robot 6 are able to be moved. The robot 6, for moving the at least one adjacent arm 55a-d of the robot 6 about the respective axis 6a-6f, can have one servomotor for each axis 6a-6f. Each of these servomotors is electrically connected to the second mains adapter 52 and is connected so as to communicate with the second control device 48.

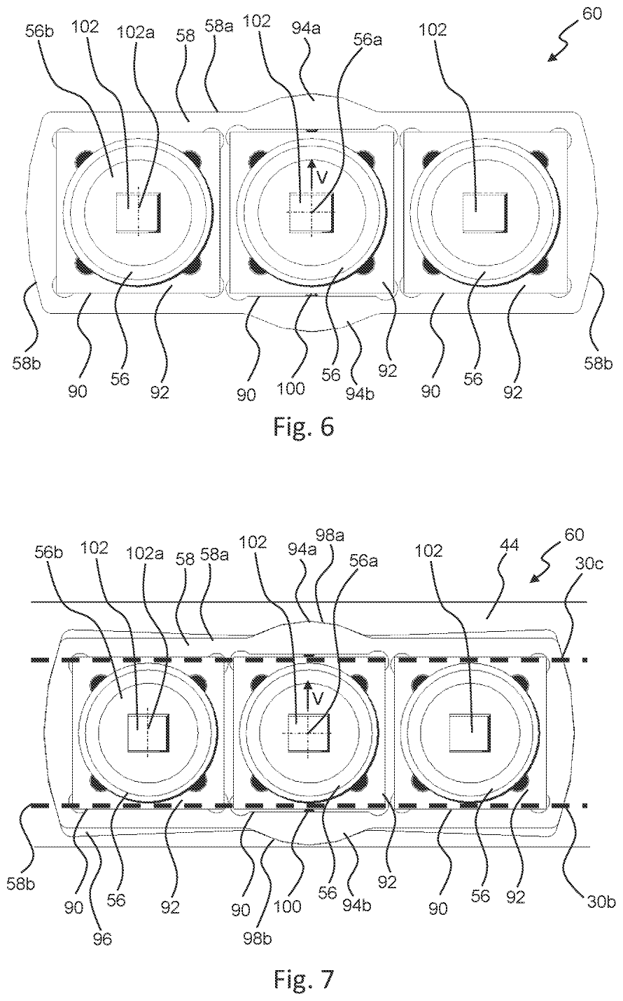

The frame 44 of the transport truck 8 is mounted so as to be movable along the packaging machine 4. To this end, the transport truck 8 comprises a plurality of casters 56, by which the frame 44 of the transport truck 8 is mounted so as to be movable on the guide rails 30, 32. The frame 44 can have one or a plurality of supports 58 on which the plurality of casters 56 are rotatably mounted. In the embodiment illustrated, the frame 44 has four supports 58, to each of which three casters 56 are attached. As a result, the transport truck 8 comprises a plurality of caster packs 60, each of which comprises at least two casters 56 of the plurality of casters 56 and one support 58. One preferred embodiment of the caster packs 60 as well as the mounting of the latter on the transport truck 8 is described with reference to FIGS. 6 and 7.

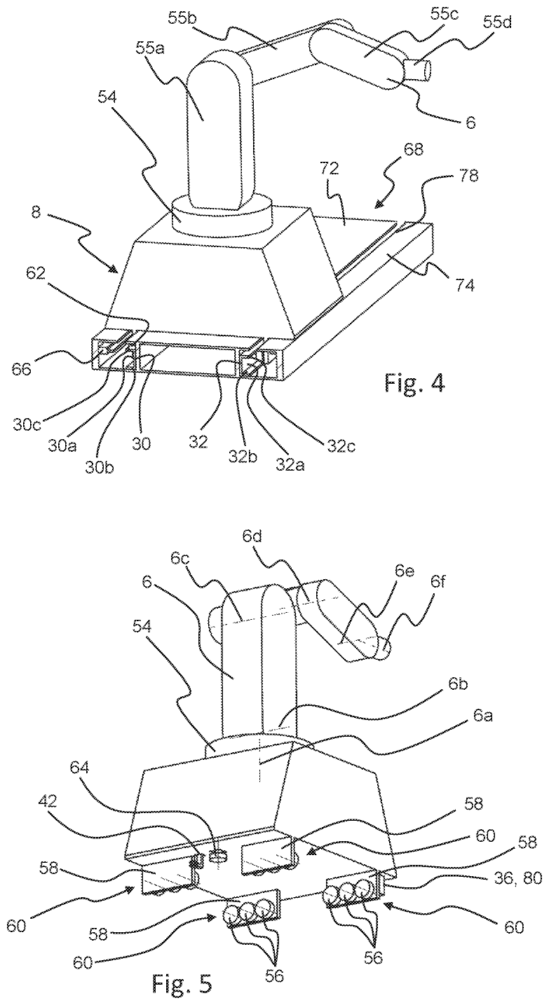

As can be seen in FIGS. 3 and 4, the guide rails 30, 32 preferably have a substantially C-shaped cross-sectional profile having in each case one first leg 30a, 32a and one second leg 30b, 32b and one third leg 30c, 32c. The second and the third leg 30b,c, 32b,c extend perpendicularly from in each case one end of the first leg 30a, 32a. The respective first leg 30a, 32a is vertically aligned, and each second and third leg 30b,c, 32b,c is horizontally aligned. As a result, the guide rails 30, 32 between the second and the third leg 30b,c, 32b,c form in each case a receptacle for the casters 56. In the normal operation, the lower two legs 30b, 32b of the guide rails 30, 32 support the load of the transport truck 8 having the robot 6. Moreover, the upper third legs 30c, 32c can absorb forces which result from a tilting moment during abrupt movements of the transport truck 8 or the robot 6. The casters 56 can particularly preferably also be axially supported on the respective first leg 30a, 32a of the guide rails 30, 32, as is derived from the description of FIGS. 6 and 7.

For moving the transport truck 8 along the packaging machine 4, the packaging plant 2 comprises a rack 62, and the drive 38 of the transport truck 8 comprises a pinion 64 which engages with the rack 62. A rotational driving movement of the drive 38 is converted to a translatory movement of the transport truck 8 along the rack 62 by way of the rack 62 and the pinion 64. The rack 62 runs along the packaging machine 4, preferably parallel to the guide rails 30, 32. As is illustrated, the rack 62 can also be arranged on a guide rail 30, in particular on the upper third leg 30c.

In order to avoid the accumulation of contamination between the teeth of the rack 62, the rack 62 and the pinion 64 are arranged so as to be horizontally next to one another. The rotation axis of the pinion 64 thus extends vertically. As a result, the teeth of the rack 62 and of the pinion 64 are directed towards the side. The tips or end faces of the teeth of the rack 62 in this instance run substantially vertically and not horizontally. It is prevented as a result that contamination can accumulate in the troughs between the teeth, good cleaning of the packaging plant 2 being facilitated as a result.

In order for the components on the transport truck 8 to be electrically supplied by way of the current collector 42, the packaging plant 2 comprises a current conductor 66 which here is configured as a conductor rail and is in sliding contact with the current collector 42. The current conductor 66 is connected to a voltage source of the packaging plait 2 and by way of the latter supplies the current collector 42 and thus the transport truck 8 with electric voltage. The current conductor 66 also runs parallel to the guide rails 30, 32, preferably so as to be spaced apart from the latter, in order to be readily accessible for the current collector 42. If two guide rails 30, 32 are provided, as is the case here, the current conductor 66 can be arranged between the two guide rails 30, 32 or preferably laterally outside the two guide rails 30, 32. The current collector 42 and the current conductor 66 preferably have a corresponding cross-sectional shape, such that the current collector 42 partially surrounds the current conductor 66 so as to ensure a reliable and uninterrupted current supply.

Further illustrated in FIGS. 3 and 4 is a cover 68 in the region of the guide rails 30, 32 which forms a casing in which the guide rails 30, 32 and preferably also the current conductor 66 and the rack 62 are received, as a result of which said guide rails 30, 32, said current conductor 66 and said rack 62 in relation to the plurality of processing stations 10, 12, 14, 16, 18 are protected against contamination. The cover 68 is configured in multiple parts and comprises a first cover portion 70, a second cover portion 72 and a third cover portion 74. The cover portions 70, 72, 74 are arranged in such a manner that said cover portions 70, 72, 74 form a gap 76, 78 above each guide rail 30, 32. In particular, a first gap 76 which is parallel to and above the guide rail 30 is configured between the first and the second cover portion 70, 72, and a second gap 78 which is parallel to and above the guide rail 32 is configured between the second and the third cover portion 72, 74. The transport truck 8 is mounted on the guide rails 30, 32 through the first and the second gap 76, 78, for example in that the supports 58 from the frame 44 extend through the first and/or the second gap 76, 78, respectively.

The ingress of contamination through the first and the second gap 76, 78 can further be minimized in that brushes (not illustrated) are arranged on each gap 76, 78, the bristles of said brushes extending transversely through the respective gap 76, 78 and thus retaining contamination, while at the same time not impeding the movement of the transport truck 8 along the guide rails 30, 32.

If the data transmission device 36 is an optical data transmission installation, as described at the outset, the data communication takes place by light beams. In order to avoid the data transmission being compromised and to ensure a reliable transmission quality, the data transmission by the data transmission device 36 takes place within the casing formed by the cover 68, this however not being mandatory. As can be seen in FIGS. 2 and 5, the data transmission device 36 can comprise a first communications interface 80 which is configured to communicate with the machine controller and below the frame 44 of the transport truck 8 is arranged on the latter. In particular, the first communications interface 80 is attached to a support 58 in order for said communications interface 80 to be placed below the cover 68.

The machine controller can be connected so as to communicate with a transmission installation 82 which is in particular configured as a transmitter. The first communications interface 80 is configured as a receiver so that the transmission installation 82 and the communications interface 80 can mutually communicate by way of a light beam 84, as is indicated in FIG. 2. It is understood that the first communications interface 80 as well as the transmission installation 82 can in each case be configured as a transmitter and receiver in order to enable bidirectional communication. It can be seen in FIG. 2 that the light beam 84 extends so as to be approximately at the height level of the casters 56. The light beam 84 is particularly preferably aligned so as to be parallel to the direction of movement and thus to the guide rails 30, 32 because said light beam thus guarantees a connection between the transmission installation 82 and the first communications interface 80, substantially irrespective of the position of the transport truck 8 relative to said transmission installation 82. In particular, the light beam 84 does not have to follow the movement of the transport truck 8 because the latter only moves parallel to the light beam 84.

If a plurality of robots 6, 6′ are provided along the packaging machine 4, it is advantageous for the data transmission device 36 to further comprise a second communications interface 86 (see FIG. 2) which is configured to communicate with a data transmission device 36′ of the further transport truck 8′. The second communications interface 86 is in particular configured as a transmitter but may also be configured as a transmitter and receiver so that the communication between the further transport truck 8′ and the transport truck 8 can take place in a bidirectional manner. The second communications interface 86 is preferably arranged and configured in a manner analogous to the first communications interface 80, with the difference that the first communications interface 80 faces the transmission installation 82 and the second communications interface 86 faces the further transport truck 8′. As a result, the further transport truck 8′ can receive a control signal which is sent from the transmission installation 82 to the first communications interface 80, is received by the latter and relayed to the second communications interface 86, and by the second communications interface 86 is sent to the further transport truck 8′ by a light beam 88.

A caster pack 60 is illustrated in more detail in FIGS. 6 and 7. The caster pack 60 comprises at least two, here three, casters 56 of the plurality of casters 56 and a support 58 on which the casters 56 are rotatably mounted. For example, the support 58 for each caster 56 has one receptacle 90 which receives and establishes a mounting 92 of the respective caster 56.

The support 58 can be configured so as to be integral with the frame 44 of the transport truck 8, can be fixedly connected to the frame 44, or can be mounted so as to be pivotable on the frame 44 of the transport truck 8, as illustrated. This can be achieved, for example, in that the support 58 comprises two bearing locations 94a,b that are preferably symmetrically arranged. The frame 44 has a recess 96 which receives the support 58 and has two bearing seats 98a,b that correspond to the bearing locations 94a,b of the support 58. The support 58 can have a substantially rectangular shape, wherein the bearing locations 94a,b are configured so as to be integral with the support 58 and in the form of a segment extend outwards from in each case a longitudinal periphery (or a broad side 58a) of the support 58. Accordingly, the bearing seats 98a,b as bearing shells are configured in the corresponding shape of a segment so that the bearing locations 94a,b and the bearing seats 98a,b are in mutual planar contact so as to permit the support 58 to pivot in the recess 96. To this end, the recess 96 in the regions next to the bearing seats 98a,b is larger than the support 58, as can be seen in FIG. 7. Further guiding of the support 58 in the recess 96 can take place on the narrow sides 58b of the support 58, in that the support 58 and the recess 96 also therein have a corresponding, preferably curved, shape and are in mutual planar contact.

Irrespective of the mounting or attachment, respectively, of the support 58 on the frame 44, it is further preferable for at least one caster 56 of the caster pack 60 to be adjustable in a direction perpendicular to a running surface of the at least one guide rail 30, 32 and preferably to a rotation axis 56a of the caster 56. In the embodiment illustrated, the central caster 56 is adjustable. The rotation axis 56a is aligned so as to be perpendicular to the drawing plane. The direction of adjustment is identified by the arrow V. The receptacle 90 of the adjustable caster 56 in the direction V is larger than the mounting 92 of the caster 56, while the width of the receptacle 90 in a direction transverse to the direction V corresponds substantially to the width of the mounting 92. As a result, the mounting 92 is received in the receptacle 90 so as to be displaceable in the direction V, and the caster 56 is correspondingly mounted so as to be displaceable in the direction V. The adjustment of the caster 56 can be performed by a threaded pin 100, for example, which is aligned so as to be parallel to the direction V.

The second and the third leg 30b,c of the C-shaped guide rail 30 are indicated by dashed lines in FIG. 7. By virtue of gravity, the two outer casters 56 bear on the second leg 30b and support the weight of the transport truck 8 and of the robot 6 on the guide rail 30. The central, adjustable caster 56 can now be precisely positioned in relation to the upper third leg 30c so that upwardly directed forces can also be transmitted to the guide rail 30 by way of said caster 56.

In principle, the transport truck 8 can also be laterally supported on the at least one guide rail 30. To this end, support casters 102 can be provided, the axis 102a of the latter being aligned so as to be perpendicular to the running surface of the guide rail 30. The support casters 102 can roll on the vertical first leg 30a, 32a of the respective guide rail 30, 32 and transmit a force to said leg 30a, 32a. The axis 102a of the support casters 102 is preferably aligned so as to be perpendicular to the axis 56a of the casters 56, and a transmission of force from the support casters 102 to the guide rails 30, 32 takes place in the axial direction of the casters 56. In one preferred embodiment, one support caster 102 is in each case rotatably mounted in a hub 56b of a caster 56, or in the mounting 92 of a caster 56.

The aspects pertaining to the arrangement and mounting of the transport truck 8 on the at least one guide rail 30, 32 described herein, in each case individually as well as in advantageous combinations, contribute towards particularly precise and reliable mounting and guiding of the transport truck 8 on the at least one guide rail 30, 32, in particular also under aggravating conditions, such as the increased mass of the transport truck 8 as a result of the latter receiving all components required for the operation, or by virtue of the stresses as a result of abrupt movements or the erroneous operation of the transport truck 8 or of the robot 6, as well as the reactive forces arising in large robots.

1. A packaging plant comprising:
a packaging machine comprising a plurality of processing stations arranged successively in a processing direction of the packaging machine; and
a robot mounted on a transport truck, wherein the transport truck is repositionable along the packaging machine;
wherein the transport truck comprises a frame, a current collector, and a plurality of operating components;
wherein the frame is mounted so as to be movable along the packaging machine, has a bearing assembly on which the robot is mounted, and supports the plurality of operating components;
wherein the current collector for transmitting an electric current to the transport truck is configured to wirelessly connect to a current source; and
wherein the plurality of operating components comprise,
a data transmission device configured to wirelessly communicate with a machine controller of the packaging machine, and
a drive for moving the transport truck along the packaging machine.

2. The packaging plant of claim 1, wherein the plurality of operating components further comprise at least one compressor.

3. The packaging plant of claim 2, wherein the at least one compressor is a compressed air compressor and/or a vacuum pump.

4. The packaging plant of claim 1, wherein the plurality of operating components further comprise at least one control device for controlling the drive and for controlling the robot.

5. The packaging plant of claim 1, wherein the transport truck comprises at least one first mains adapter and one second mains adapter which are in each case electrically connected to the current collector, wherein the first mains adapter for the electrical power supply of the plurality of operating components on the transport truck is configured to convert an input voltage to a first output voltage, and wherein the second mains adapter for the electrical power supply of the robot on the transport truck is configured to convert the input voltage to a second output voltage.

6. The packaging plant of claim 1, wherein the plurality of operating components further comprise at least one sensor, wherein the at least one sensor is selected from an optical sensor for identifying goods to be transported, for documenting the operation of the robot or for monitoring an environment of the robot, a position sensor for identifying the position of the transport truck or of the robot, an acceleration or vibration sensor for monitoring the transport truck or the robot.

7. The packaging plant of claim 1, wherein the packaging plant comprises at least one guide rail which runs along the packaging machine and extends at least in portions parallel to the processing direction, wherein the frame of the transport truck is mounted so as to be movable on the at least one guide rail.

8. The packaging plant of claim 1, wherein the transport truck comprises a plurality of casters and the frame of the transport truck by the plurality of casters is mounted so as to be movable on the at least one guide rail.

9. The packaging plant of claim 8, wherein the transport truck comprises a plurality of caster packs, wherein each of the plurality of caster packs comprises at least two casters of the plurality of casters and a support on which the at least two casters are rotatably mounted, wherein the support is mounted so as to be pivotable on the frame of the transport truck.

10. The packaging plant of claim 9, wherein a first caster of the at least two casters of each caster pack is adjustable in a direction perpendicular to a running surface of the at least one guide rail.

11. The packaging plant of claim 10, wherein the direction perpendicular to the running surface of the at least one guide rail is perpendicular to a rotation axis of the caster.

12. The packaging plant of claim 1, further comprising a current conductor, wherein the current collector of the transport truck is in sliding contact with the current conductor.

13. The packaging plant of claim 12, wherein the current conductor is a conductor cable or a conductor rail.

14. The packaging plant of claim 1, further comprising a rack which runs along the packaging machine, wherein the drive of the transport truck comprises a pinion which engages with the rack.

15. The packaging plant of claim 1, further comprising at least one further robot which is mounted on a further transport truck, wherein the further transport truck is repositionable along the packaging machine.

16. The packaging plant of claim 1, wherein the data transmission device is an optical data transmission device.

17. The packaging plant of claim 15, wherein the data transmission device comprises a first communications interface and a second communications interface, wherein the first communications interface is configured to communicate with the machine controller, and the second communications interface is configured to communicate with a data transmission device of the further transport truck.

18. The packaging plant of claim 1, wherein at least one first processing station of the plurality of processing stations is arranged in a clean room, and the robot in the region of the first processing station is also arranged in the clean room.

19. The packaging plant of claim 1, wherein the plurality of processing stations comprise at least one forming station, one filling station, one sealing station, one punching station, and one cartoner, wherein the robot is repositionable along all processing stations of the plurality of processing stations, and
wherein the packaging plant comprises at least one assembly area for consumable material and the robot is configured to supply the plurality of processing stations with consumable material.
